(19) United States
(12) Patent Application Publication
(10) Pub. No.: US 2003/0163526 A1
(43) Pub. Date: Aug. 28, 2003

(54) Virtual direct connect network

(76) Inventors: Olivier Bernard Clarisse, Des Plaines, IL (US); Pascal Collet, Oak Park, IL (US); James Patrick Dunn, Sandwich, IL (US); Bruce A. Westergren, St. Charles, IL (US)

Correspondence Address: Werner Ulrich, 434 Maple Street, Glen Ellyn, IL, 60137-3826, US

(21) Appl. No.: 10/082,561

(22) Filed: Feb. 25, 2002

(51) Int. Cl. G06F 15/16; H04Q 11/00; H04L 12/16

(52) U.S. Cl. 709/204; 379/900; 370/260; 709/227

(57) ABSTRACT

Apparatus and a method for requesting establishment of a virtual connection for transmitting voice signals over a packet network. In response to operation of a soft button, the signaling messages for establishing a pre-specified point-to-point connection, conference connection or one-way conference connection are automatically generated. Advantageously, complex pre-specified connections can be established in response to the operation of a soft button.

### TECHNICAL FIELD

This invention relates to networks of Internet Voice Connections.

### PROBLEM

In traditional phone networks, there are always requirements for special arrangements to serve rapid connections. These include hot line, or direct connect features, that connect to a particular number as soon as the phone is taken off-hook. Other arrangements are used in Defense networks providing special purpose lines and connections that are never released. Another arrangement is used in custom stock brokerage systems using phones with multiple call appearances, where a broker can call the trading floor before the market opens and leave the connection up until the market closes. The common need in all of these arrangements it to be able to talk to the party on the other end without delay, such as dialing and routing.

The problem with such services is that the long holding times can cause blocking for typical customers. To engineer special switching equipment for these types of networks is very expensive, but is often done because of the cost of delay (missed stock trade, late missile launch, etc.).

### SOLUTION

The above problem is solved and an advance is made over the prior in accordance with this invention, wherein by extending packet voice protocols, such as the Internet H.323 Protocol and SIP (Session Initiation Protocol) (Internet Engineering Task Force—RFC 2543), to allow each direct connection to be activated in response to a customer's pressing a software control “button” (“soft button”) associated with that connection. Advantageously, by using virtual connections, the holding time of the connection is reduced to the holding time of the actual packet connection used between the source and destination.

In accordance with one preferred embodiment of Applicants' invention, the connection may be from one point to another, or it may be a conference connection, wherein a plurality of telephones are completely interconnected, or it may be a one way conference interconnection, wherein one speaker, such as a Crisis Manager, can simultaneously give a message to a plurality of telephones such as those of the Crisis Manager's colleagues.

In accordance with one specific embodiment of the invention, an IP (Internet Protocol) telephone instrument can be concurrently connected on a plurality of individual connections, and/or conference connections. These concurrent connections can be initiated by the customer via dialing procedures, or they can be permanent connections. The advantage of permanent connections is that the parties can communicate without any call control signaling or set-up delay.

In accordance with one preferred embodiment of the invention, a proxy server attached to the Internet is used to establish the permanent connections via Internet Telephony Protocols, such as ITU, (International Telecommunications Union) H.323 and SIP, that support third party IP telephony signaling. Alternatively, a multimedia control system such as the API, (Application Programmable Interface) Parlay, (the Parlay Group http://www.parlay.org), can be used to establish broadband connections.

A given Virtual Direct Connect Network can have any number of narrow band or broadband connections. The proxy server determines from its program and database which parties are required on the Virtual Direct Connect Network, and the appropriate signaling protocol for each party. The proxy may be programmed by the Administrator, or the proxy can provide a user interface to one or all of the users. In accordance with one of the embodiments of the invention, all users are provided a user interface via the Internet and a standard web browser program resident on the IP telephony instrument, or a designated PC.

In accordance with one embodiment of the invention, the users can choose to be active on the voice connection; monitor status, text, or video; place the connection on hold; forward the connection; or move the connection to a different end point. When users are active on a connection, they can send/receive voice, text, video and/or control information to the other users. In accordance with one embodiment of the invention, an active user can send a message to a program on the IP telephony instrument of one or more users that are on hold to alert them to actively rejoin the connection.

In accordance with one embodiment of the invention, the connections are made using standard network elements. The proxy sends the required message(s) to the network element(s) that are required to make the connections specified in the proxy database. For example, if the proxy is setting up a connection between two H.323 end points, it would send a set-up request to the network element, such as an IP telephony switch like the Lucent SoftSwitch (LSS), manufactured by Lucent Technologies Inc. The network element would allocate LSS resources (memory and software resources such as process control bocks, process headers, process identifications) for the connection, and then generate the appropriately formatted set-up request for each of the end points. For a normal call establishment, each end point would return an acknowledge message to the LSS to confirm that the set-up request had been received and was being processed. The end points then communicate directly using the H.245 Protocol to negotiate parameters of the call. The end points can then communicate directly using the negotiated parameters. The end points then return the parameters of the call with the connect request to the LSS. The LSS changes the call state to connect, and monitors for the disconnect. The details of how to establish connections and negotiate connection parameters are well known in the industry.

### BRIEF DESCRIPTION OF THE DRAWING(S)

FIG. 1 is a block diagram illustrating one configuration of Applicants' invention;

FIG. 2 illustrates a preferred embodiment of Applicants' invention, including a proxy server;

FIG. 3 is a block diagram of a proxy server;

FIG. 4 is a block diagram of end user's equipment for use with this invention;

FIG. 5 is a flow diagram of Virtual Direct Connect Program;

FIG. 6 is a flow diagram of a Client Applet/Servlet Program;

FIG. 7 is a layout of memory in the proxy server; and

FIG. 8 is a layout of memory in the Internet.

### DETAILED DESCRIPTION

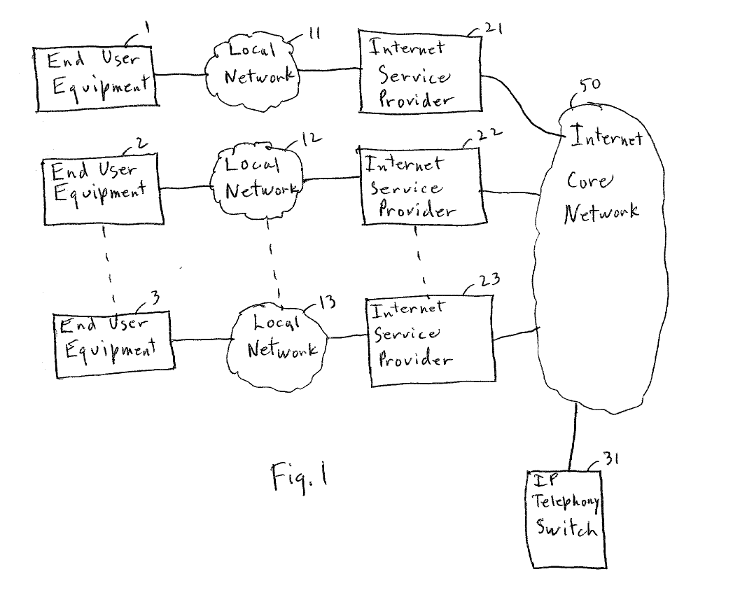

FIG. 1 illustrates a plurality of users having end user equipment (1), (2), . . . , (3), and connected to the Internet. Each of these users has equipment that is connected via a local network (11), (12), . . . , (13), respectively, to Internet Service Providers (ISPs (21), . . . , (22), . . . , (23). In response to requests that these users be connected to voice connections on the Internet, the service providers provide a connection to an Internet core network (50), which has the ability to connect any port appearing on the network to any other such port. An Internet Protocol Telephony Switch (31), provides signaling messages to the Internet to establish the desired connections.

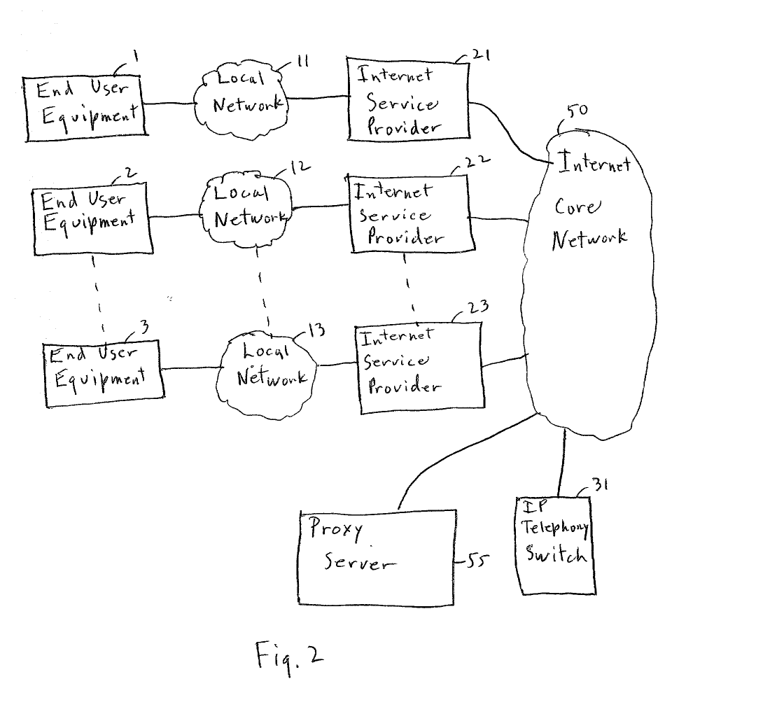

FIG. 2 is the same as FIG. 1, with a proxy server (55) added. The purpose of the proxy server is to store the connections required for the Virtual network. The proxy server formulates the set-up request messages and transmits them to the telephony switch for establishing the calls. The proxy server communicates with the end user equipment to receive information about the virtual network connections. In this example, the virtual network connections are all the connections among the members of a Crisis Management Team, who can be flexibly interconnected, either by one-to-one connections, or by conference connections, or by broadcast connections, depending on the particular immediate need caused by the crisis. When an end user signals a request for a connection, the end user's equipment sends a message representing that request. The end user actually activates a program by operating a software control “button” (a “soft button”) by, for example, touching the screen or using a cursor, to specify the type of service that should be activated. The proxy then determines the types and contents of messages required to activate these services, and sends these messages to the IP Telephony Switch in order to cause the appropriate connection within the virtual network to be established. The messages from the proxy server supply the details about the end points to be connected, in response to the original cursor or screen touch information from the end user equipment. The end points then negotiate the call.

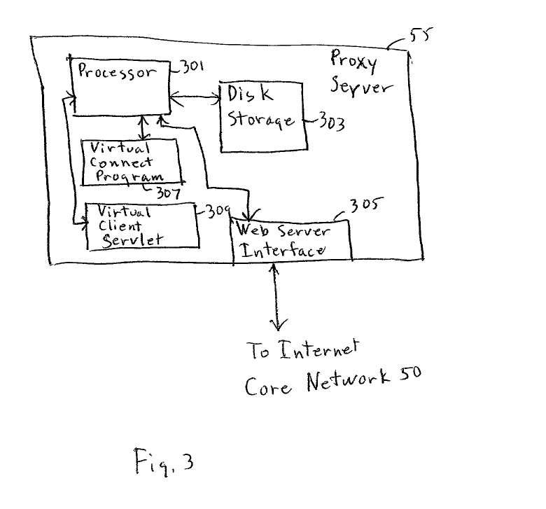

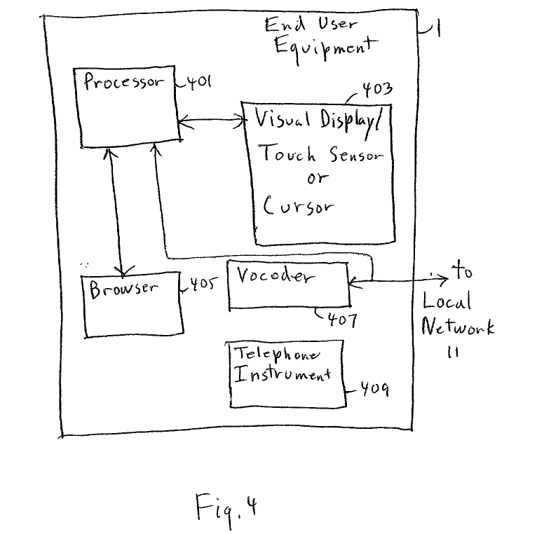

FIG. 3 is a block diagram illustrating the details of the proxy server (55). A processor (301) has access to disk storage (303), a web server interface (305), a virtual connect program (307), and a virtual client Servlet (309). The virtual connect program allows the proxy server to send instructions to the Internet to establish particular virtual connections, and provides details as to the bandwidth required for these connections. The virtual client server allows the proxy server to interact with a browser (405, FIG. 4). The web server interface is the interface between the proxy server and the end user browser.

FIG. 4 illustrates the end user's equipment (1); this includes a processor (401) connected to a visual display (403), with a touch sensor or cursor to allow a user to request whatever is represented on the appropriate section of the screen. The end user equipment is also supplied with software in a browser (405). This browser converts the results of the touch sensor response, or cursor response, into a message to be sent to the proxy server. In addition, the proxy server interacts with the end user's browser to control the visual display at the end user equipment. The end user equipment also includes a Vocoder (407) to convert between signals from a telephone instrument (409) and H.323 Protocol IP packets.

In an alternative embodiment, the logic of a Servlet can be implemented in an applet run by the browser, in which case, the Servlet (309), (FIG. 3), is not needed. (The applet and Servlet perform the same functions). The advantage of using the Servlet is that the trade secrets of the Servlet are not exposed to the end user; further, the memory requirements of the end user equipment are reduced. The disadvantage of using Servlets is that the server equipment needs to be sized to support the number of users, (i.e., the load).

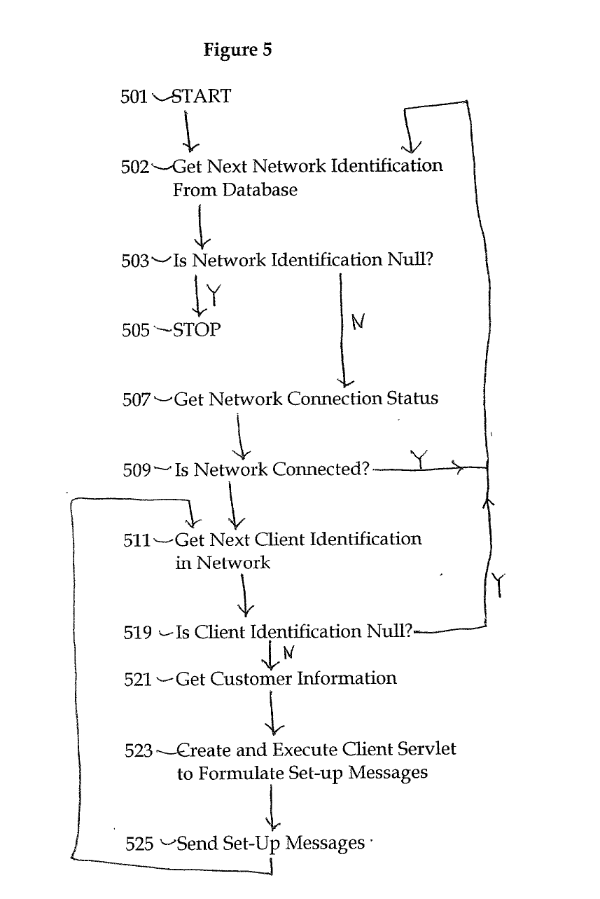

FIG. 5 illustrates the process of setting up the virtual direct connect database in the proxy server (55). The process is initiated at START Block (501). This can be following an initialization of the system. The next network is retrieved from database, Action Block (502); if no next network is available, a null network identifier is returned. Test (503) tests whether a null network identifier has been returned. If a null network identifier has been returned, then Action Block (505) to STOP the process is entered. If there are more networks, then the connection status of the next network being processed is obtained, Action Block (507). Test (509) is used to determine whether paths in the network are, in fact, connected. If not, then Action Block (511) is entered to obtain data for the next client to be connected in the network. If no clients need to be connected, i.e., if the next client identifier is a null client, (positive result of Test (519)), then Action Block (502) is re-entered. If a client of this network needs to be connected, (negative result of Test (519)), then Action Block (521) is entered to get customer information about the end point of this network. Action Block (523) is entered to start the client Servlet of the proxy server to formulate the set-up messages based on this customer information. Then Action Block (525) is entered to send set-up messages for processing by the IP Telephony Switch. Then, Action Block (511) is re-entered to retrieve the next client, (if any), to be connected in the network.

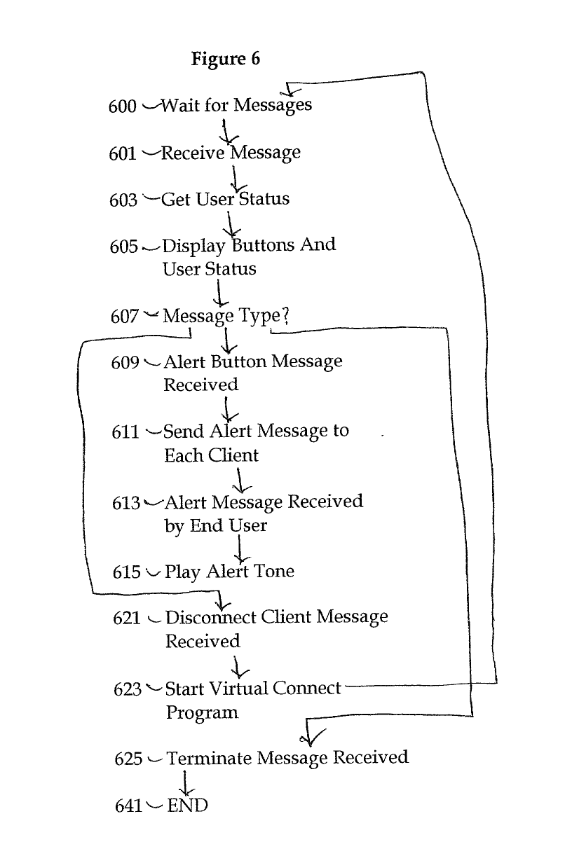

FIG. 6 illustrates the program that is executed in the server to monitor the end user's equipment. It is an expansion of the bulk of Action ((523), FIG. 5). Initially, Action Block (600), the server is waiting for messages. When a message is received, Action Block (601), the user status is obtained via queries to the IP Telephony Switch, Action Block (603). The control buttons and user status for all users are then displayed to each user, Action Block (605). Test (607) monitors messages from the users, and determines what type of message was received. If the type of message that was received as an Alert Button Message, Action Block (609), then an Alert Message is sent to each of the other users, Action Block (611). From the point of the user, if an Alert Message has been received by an user, Action Block (613), then the Alert tone is played, Action Block (615). If the type of message that is received by the server was a Client Disconnect Message, Action Block (621), then the Virtual Connect Program, (Action Block (501), FIG 5), is started to re-establish the call, Action Block (623). Following the execution of Action Blocks (615) or (623), Action Block (600) is re-entered. If a Terminate Message is received, Action Block (625); then Action Block (641) is executed to end the application.

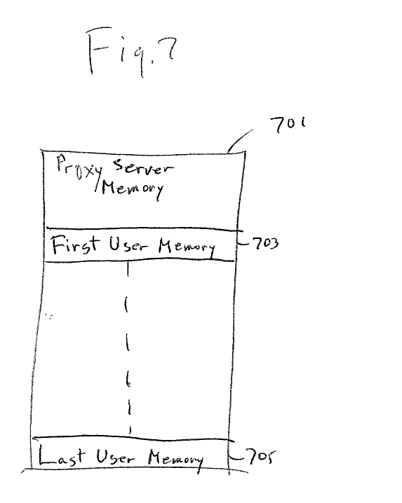

FIG. 7 is a layout of memory in the proxy server. Block (701) comprises the proxy server memory. The proxy server memory includes a Block (703) for a first user, . . . , and a Block (705) for the last user. In one exemplary embodiment, the block of data for each registered user includes the name, an abbreviated address, a handle for identifying the customer internally, a password for that customer, an E-Mail address, a telephone number, and an indication of which networks that customer belongs to.

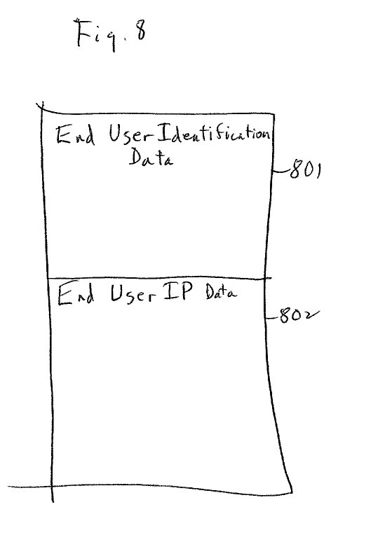

FIG. 8 illustrates the layout of information stored with the end user. In one preferred embodiment, the information includes an identification Block (801), including a user identification. The user identification includes a location, (for example, a user's specific client end-point; an identification number, (e.g., a telephone number used to identify the user client in the network), an identification of the protocol used by that end user; an identification of the port to which that user is connected; an identification of the proxy server; an identification of the Registrar for that user; (the Registrar records the physical address of the client and associates that address with the identification number), and an identification of the various options available to that user, (for example the type of audio compression algorithms supported by the end point, graphics support, text messaging support).

Block (802) is the memory for the end user's Internet Protocol (IP) data. In a preferred embodiment, this includes an IP address assigned to the user; a Gateway IP address accessed by the user; the proxy server's name or IP address; the IP address Domain in which the user is located; the IP address of the Domain name server; the method of address allocation (e.g., static IP address or dynamic address allocated to the client by the IP network); and the communication protocol used for voice bearer and signaling.

The above description is of one preferred embodiment of Applicants' invention. Other embodiments will be apparent to those of ordinary skill in the art, without departing from the scope of the invention. The invention is only limited by the attached Claims.

We claim:

1. Apparatus for establishing a pre-configured multi-port telecommunications connection, comprising:
an Internet network; and
a plurality of end user stations connected to said Internet network;
at least one of said stations having soft button capabilities for generating a message identifying a soft button, in response to an operation of said soft button;
means for receiving said message, and for generating signaling messages for activating pre-specified connections corresponding to connections requested by said at least one station, in response to the operation of one of said soft buttons.

2. The apparatus of claim 1, wherein the means for activating said connections comprises a proxy server for sending signaling messages to the Internet to activate said requested connections.

3. The apparatus of claim 2, wherein said proxy server comprises a Servlet program for controlling the sending of signaling messages to the Internet to activate said requested connections.

4. The apparatus of claim 2, wherein said at least one end user station comprises an applet program for generating said signaling messages.

5. A method for establishing a pre-configured multi-port telecommunications connection, comprising the steps of:
connecting a plurality of end user stations connected to an Internet network;
providing at least one of said stations with soft button capabilities for generating a message identifying a soft button, in response to an operation of said soft button; and
receiving said message, and generating signaling messages for activating pre-specified connections corresponding to connections requested by said at least one station, in response to the operation of one of said soft buttons.

6. The method of claim 5, wherein the step of activating said connections comprises providing a proxy server for sending signaling messages to the Internet to activate said requested connections.

7. The method of claim 6, wherein said proxy server is responsive to a Servlet program for controlling the sending of signaling messages to the Internet to activate said requested connections.

8. The method of claim 6, wherein the step of generating said signaling messages comprises the step of using an applet program to generate said signaling messages.
